(19) United States
(12) Patent Application Publication
(10) Pub. No.: US 2011/0264516 A1
(43) Pub. Date: Oct. 27, 2011

(54) LIMITING LATENCY DUE TO EXCESSIVE DEMAND IN AD EXCHANGE

(75) Inventors: Kevin Lang, Mountain View, CA (US); Joaquin Arturo Delgado Rodriguez, Santa Clara, CA (US); Chavdar Botev, Sunnyvale, CA (US)

(73) Assignee: Yahoo! Inc., Sunnyvale, CA (US)

(21) Appl. No.: 12/767,952

(22) Filed: Apr. 27, 2010

(51) Int. Cl. G06Q 30/00

(52) U.S. Cl. 705/14.46; 705/14.73; 705/14.71

(57) ABSTRACT

A method is disclosed for limiting latency in filling a display opportunity in an ad exchange including: constructing an exchange graph comprising nodes representing a plurality of publishers and advertisers, the exchange graph also including a plurality of directed edges that represent bilateral business agreements connecting the nodes; receiving an opportunity for displaying an ad to a user, wherein the opportunity is associated with a publisher node; receiving ads from the advertisers from which to choose to fill the opportunity; determining whether a threshold total number of ads (T) is surpassed by the received ads; and randomly downsampling the number of ads from each of at least some of the advertisers when the threshold total number of ads (T) is surpassed by the received ads to reduce the total number of ads to a target number of ads (S) that reduces overall latency in determining which of sampled ads will fill the opportunity.

### RELATED APPLICATIONS

The present disclosure is related to U.S. patent application Ser. No. 12/749,151, entitled EFFICIENT AD SELECTION IN AD EXCHANGE WITH INTERMEDIARIES, filed Mar. 29, 2010, which is hereby incorporated by reference.

### BACKGROUND

1. Technical Field

The disclosed embodiments relate to an ad exchange auction within a directed graph, and more specifically to limiting latency in a non-guaranteed (NGD) exchange when dealing with an excessive demand by way of advertisements (ads) from advertisers.

2. Related Art

In advertising auctions, publishers create display opportunities for online advertising on their web pages, which are published to the Internet (or World Wide Web). These include an inventory of advertising slots, also referred to as advertising supply. Advertisers have a demand of advertisements (ads) with which they want to fill the advertising slots on the publisher web pages. The ads of the advertisers may be matched, in real time, with specific display opportunities in an ad exchange, which is described in detail below.

In the tragedy of the commons, multiple individuals, acting independently, and solely and rationally consulting their own self-interest, will ultimately deplete (or destroy) a shared limited resource even when it is clear that it is not in anyone's long-term interest for this to happen. This has been observable recently in the growing numbers of ads submitted by advertisers in an auction handled by an ad exchange of Yahoo! of Sunnyvale, Calif. The resource being consumed is the speed at which the NGD exchange server and affiliated hardware can operate when processing too many advertisements (ads) for any given auction.

Because a growing number of advertisers function under a cost-per-action (CPA) or cost-per-click (CPC) basis, they have no reason to curb the number or types of ads they submit for an auction to the ad exchange because they need not pay a publisher or the auction broker, Yahoo!, for display of the ad until a user performs a specific action, usually defined as a purchase on the website of the advertiser. In contrast, advertisers operating under contracts that require them to pay on a cost-per-mille (CPM) basis must pay per impression, which means they pay for the instances in which users view the ads, regardless of their actions taken thereon. Those functioning under a CPA or CPC basis generally are the advertisers submitting too many ads, including so-called “junk” or “spam” ads, because there is no incentive to figure out which ads yield the best results and submit only those ads when they need not pay anything until they have success. It is like throwing mud on a wall and getting paid for what sticks: the more mud the better.

This multiplicity of ads clog up the exchange server that needs to perform much analysis on the ads to determine which ones are reachable along a valid path through an ad exchange graph traced from a publisher page to the ads, which is discussed below. The exchange server then makes a call out for bids from the advertisers of those ads. If the real-time auction were to complete more slowly, the call out for bids would be delayed, and an ad would be chosen and delivered more slowly for display to a user who, by then, may have browsed away from the publisher's page before seeing the advertisement. To avoid this, more resources, and thus money, must be expended to keep up with rising demand, which costs are passed down to, primarily, pay-per-impression advertisers. Accordingly, those advertisers that generally are not the cause of the problem become those that pay the price for it, although the CPA and CPC advertiser costs also go up, so all are affected as is the case in the tragedy of the commons.

Further by way of background, an ad-network is a business that operates an exchange on behalf of a collection of publisher customers and a collection of advertiser customers, and is responsible for ensuring that the best, valid ad from one of its advertisers is displayed for each opportunity that is generated in real time by one of its publishers. Traditionally, an ad-network would do this by running its own ad servers, but now it can instead delegate its ad-serving responsibilities to an ad-exchange such as Yahoo! of Sunnyvale, Calif., which can be viewed as a “meta-ad-network” that operates on behalf of a collection of ad-networks, and transitively the publishers and advertisers managed by those ad-networks, plus some “self-managed” publishers and advertisers that participate directly in the ad-exchange.

While each ad-network operates as an ad exchange, ad-networks in general do not want the trouble and expense of running their own ad servers required to execute the ad exchange. The ad networks still want, however, a simple method for setting up pairwise, opportunity-forwarding agreements, with automatic mechanisms for revenue sharing and for ensuring the consistent application of business logic that keep their publishers and advertisers satisfied, despite the participation of publishers and advertisers of other ad networks. Setting up such opportunity-forwarding agreements in an automated fashion ensures additional revenue sharing opportunities for publishers and advertisers. If the pool of publishers and advertisers can be cross-expanded with other ad networks, each ad network benefits economically to a great extent. To provide this economic benefit without the concomitant costs and resources of running a server to adequately do so, the meta-ad-network operates as a meta-ad-exchange to connect publishers and advertisers across multiple ad-networks.

The meta-ad-exchange (or “exchange” for simplicity) operates one or more ad servers, which have required more resources as the number of participating ad-networks, publishers, and advertisers has grown. The business relationships between these entities can be represented in the exchange as an exchange graph including nodes that represent the ad-networks, the publishers, and the advertisers. Additionally, the exchange graph includes edges that connect the nodes that may include one or more predicates, which in a broadest sense, are the parts of propositions that are affirmed or denied about a subject. Such a subject in this case could be a constraint or requirement of some kind, such as arising from a contract or other business relation germane to the meta-ad-network. In a simplistic scenario of ad selection, the exchange graph 200 is “flat,” like a classical ad-network shown in FIG. 2, meaning that advertisers 104 and publishers 108 can be directly matched up during any given ad serving transaction, subject to feasibility and optimality requirements, which can be the subject of the predicates.

The exchange, and thus the graph on which the exchange server operates, has had dramatic recent growth that in terms of complexity and volume. Table 1, below, shows the trends of this growth during three months of 2009, but these growth trends continue to date. As shown, the growth is due to the increased number of campaigns and creatives (or ads) processed, leading to an increased number of predict calls: a 229% increase in three months.

TABLE 1

| Count Metrics | May 06, 2009 | August 04, 2009 | Increasing Rate |
|---|---|---|---|
| nodes | 252 | 302 | 20% |
| advertisers | 195 | 232 | 20% |
| edges considered | 33,305 | 34,394 | 3.3% |
| edges copies | 2,114 | 2,754 | 30% |
| campaigns | 39,457 | 66,170 | 68% |
| processed | | | |
| creatives proccesed | 28,388 | 52,028 | 83% |
| predict calls | 2,636 | 8,666 | 229% |

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the present disclosure. In the drawings, like referenced numerals designate corresponding parts throughout the different views.

FIG. 1 is a block diagram of an exemplary system for limiting latency due to excessive demand in an ad exchange.

FIG. 2 is a prior art exchange graph diagram showing the classic “flat” ad matching problem, which has been affected by excessive demand.

FIG. 3 is an exchange graph diagram showing an ad matching problem that includes intermediate ad-network entities, which has also been affected by excessive demand.

FIG. 4 is a diagram of a directed multigraph showing some of the main features of the exchange graph that includes intermediate ad-network entities.

FIG. 5 is another exchange graph diagram, showing a counterfactual scenario where the exchange contains no legality constraints.

FIGS. 6A, 6B, 6C, and 6D is a series of related exchange graph diagrams, showing the progression of a core algorithm for ad selection of a sample ad in an ad exchange with intermediate ad-network entities.

FIGS. 7A, 7B, and 7C are flow diagrams of an exemplary method for efficient ad selection in an ad exchange with intermediate ad-network entities, according to an embodiment.

FIG. 8A is a graph of the advertisers in relation to the number of ads per advertiser, and that displays as the area under the graph the number of ads for an ad call that are greater than the threshold (T) number of ads above which the advertisers will be sampled.

FIG. 8B is a graph corresponding to that of FIG. 8A indicating that a number of sampled ads (S) removes from the auction a number of the ads from the most participating advertisers.

FIG. 9 is a graph depicting the difference in average number of ads participating per ad call between sampling and not sampling the top 50 advertisers out of 400 considered the most participating advertisers.

FIG. 10 is a flow diagram of an exemplary method for limiting latency in filling a display opportunity in an ad exchange.

FIG. 11 illustrates a general computer system, which may represent any of the computing devices referenced herein.

### DETAILED DESCRIPTION

By way of introduction, included below is a system and methods for limiting latency due to excessive demand in an ad exchange. As discussed above, the inundation of Yahoo!'s Non-Guaranteed (NGD) Exchange server with an excess of advertisements (ads) has worked to deplete the resources of the exchange server, thus causing increased costs to maintain the server. These costs, of necessity, are passed down and affect all participant advertisers, thus creating a tragedy of the commons. More tragic, however, is that statistically, only a handful of abusive—or most participating—advertisers drive up the prices for all advertisers. Herein, the terms “abusive,” “abuser,” or “most participating” are meant to refer to an advertiser that abuses the NGD exchange by the submission of excessive numbers of ads in an auction for any given display opportunity. Accordingly, what is needed is one or methods by which the exchange server can decrease, such as by downsampling, the number of ads from the most participating advertisers.

The cost of computation, as will be apparent herein, increases with the size and complexity of the exchange. This disclosure discusses efficient ad selection in an ad exchange with intermediate ad-network entities, to deal with such increasing complexity, as well as methods by which only a smaller number of ads (S) of a submitted pool of ads are considered in the auction to reduce latency of ad serving. For instance, the disclosure discloses methods by which some of the participating advertisers are randomly downsampled to reach this size (S), creating a fairer auction for all participating advertisers.

Unlike many other ad-networks and “flat” exchanges, Yahoo!'s NGD Exchange contains not only publishers and advertisers, but also intermediate ad-network entities that can link together publishers and advertisers that do not have direct relationship. The latency-reducing embodiments may function on a flat exchange or one including ad-network entities. The NGD Exchange has recently experienced significant growth in impressions and revenue. An impression is created any time a user is exposed to an ad, e.g., a web page is downloaded on the browser of a computer of the user containing an advertisement. Each ad includes a creative or image of some kind, usually some text, and a uniform resource locator (URL) link to a landing page of the advertiser associated with the ad.

Given the recent business growth, the NGD ad exchange server as previously-executed exhibited scalability and performance problems. A solution was needed that uses existing serving interfaces and front-end/back-end data structures to support the growth of business by scaling gracefully with business metadata, and ultimately to support the NGD exchange with greater depth. Also desired were lower latencies and larger query per second (QPS) rates per ad server. Likewise, the NGD exchange servers needed to support a latency-bounded model that allows for revenue versus latency trade-offs through simple run-time adjustments, also referred to herein as knobs. Finally, designers sought to formulate the exchange serving abstractions and architecture of the NDG exchange in a manner so as to decouple the exchange network marketplace (entities, business relationships, constraints, budgets) from the ad marketplace (advertiser bids, response prediction, creatives). While the current application does not address solutions to all of these goals, it does deal with some of them as related to efficient ad selection and limiting latency due to excessive demand within the NDG exchange.

As discussed, the ad exchange includes publishers and advertisers, as well as intermediate ad-network entities in many cases, all represented in an exchange graph with nodes, and further includes edges that interconnect the nodes, thus creating a multiplicity of possible paths. The edges include predicates with which compliance is required in order to traverse the path to fill an opportunity with a specific advertisement from a specific advertiser. This is a more complicated scenario than a “flat” ad exchange: the predicates associated with edges along a path include intermediaries that introduce complications into ad selection that are often intractable in resolution. This is because now, not only must a winning advertiser bid be chosen, but a winning (ad, path) pair needs to be found to maximize profit to the publisher that generated the opportunity while also meeting all legality predicates along that path.

Moreover, the legality of a path depends not only on the individual legality of the edges of a path given the current display opportunity, but also on constraints that allow edges to have veto power over the endpoints of the path, which are additional predicates. In the ad serving role, therefore, an exchange needs to, in real time and with low latency, select an ad and a path leading to that ad, subject to feasibility and optimality requirements which can depend on the characteristics of the particular user who is at that moment loading a web page from a website of a publisher.

Proposed herein is an efficient, polynomial-time algorithm for solving this constrained path optimization problem so as to provide a scalable—and low latency—ad serving solution. Despite the fact that the number of candidate paths can grow exponentially with graph size, this algorithm exploits the optimal substructure property of best paths to achieve a polynomial running time. To further improve its speed in practice, the algorithm also employs a search ordering heuristic that uses an objective function to skip certain unnecessary work. Experiments on both synthetic and real graphs show that compared to a naive enumerative method, the speed of the proposed algorithm ranges from roughly the same to exponentially faster.

Furthermore, the present methods disclose reducing the size of an ad pool if it is too large, thereby reducing ad serving latencies. Two parameters are used in one embodiment, T that specifies the target number of ads required to trigger random sampling that will reduce the ad pool size, and S that specifies the size of the smaller ad pool that will be selected after the random sampling, where T>S. Because downsampling all advertisers by a set percentage would be unfair to those advertisers that are not abusers and that submit fewer ads, sampling a particular advertiser may be made contingent on the ads submitted by the advertiser exceeding a function that varies with the number of submitted ads by that particular advertiser. Possible functions and the particulars of these methods will be explained in more detail below.

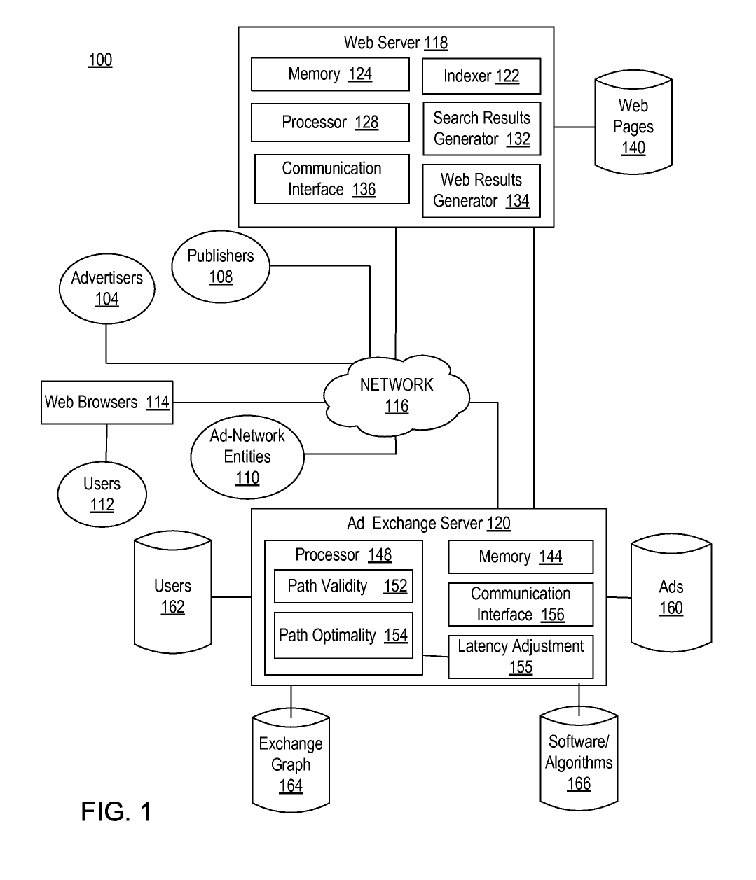

As shown in FIG. 1, a system 100 for limiting latency due to excessive demand in an ad exchange includes a plurality of advertisers 104, publishers 108, and may include ad-network entities 110. The system 100 further includes users 112 that access web pages on publisher websites through web browsers 114 over a communications network 116. The users 112 may access and download web pages on their client computers or other network-capable computing device, such as a desktop, a laptop, or a smart phone (not shown). The communications network 116 may include the Internet or World Wide Web (“Web”), a wide area network (WAN), a local area network (“LAN”), and/or an extranet or other network.

The system 100 includes a web server 118, which may include a search engine as well as general delivery of publisher web sites browsed to by the Web users 112, and includes one or more ad exchange server 120 such as already briefly discussed, all of which are coupled together, either directly or over the communications network 116. Herein, the phrase “coupled with” is defined to mean directly connected to or indirectly connected through one or more intermediate components. The ad exchange server 120 may be integrated within the web server 118 in some embodiments. The ad exchange server 120 receives a request from the web server 118 for ads to be delivered to a search results or other page (not shown) in response to a query submitted by a user 112 or to a browsing or linking action that led the user 112 to download a publisher web page. The request creates an advertisement display opportunity, whether on a search results page or another web page of a publisher website. Accordingly, the web server 118 may host one or more affiliate publishers 108.

The web server 118 may include an indexer 122 or the indexer may be executed remotely on another computing device, and be coupled with the web server 118 over the network 116. The web server 118 may further include a memory 124 to store computer code or instructions, a processor 128 to execute the computer code or instructions, a search results generator 132, a web page generator 134, a communication interface 136, and a web pages database 140. The indexer 122 indexes the web pages of the database 140 according to keyword terms that relate to the content of the web pages and that are likely terms to be searched for by the users 112.

The indexer 122 indexes the web pages stored in the web pages database 140 or at disparate locations across the communications network 116 so that a search query executed by a user will return appropriately-relevant search results. When a search is executed, the search results generator 136 generates web results that are as relevant as possible to the search query for display on the search results page. Indeed, organic search results are ranked at least partially according to relevance. Also, when the search query is executed, the web server 118 requests appropriately-relevant ads from the ad exchange server 120 to be served in sponsored ad slots of the search results page.

If a user 112 browses or links to a publisher website, which may be through a search results page, a search engine page, or any other publisher website, the web page generator 134 supplies the web page for download by the user 112 accessing the same. Before supplying the web page, however, the web server 118 requests that the ad exchange server 120 deliver an ad that may be not only relevant to the web page being downloaded, but also that somehow targets the user 112 downloading the web page. Again, this creates an ad display opportunity, which requires that the ad exchange server 120 process the ad exchange graph, which is stored in an ad exchange database 164, to compute bids from advertisers for ads that are valid for the opportunity. The ad exchange server 120 internally runs an auction on behalf of the publisher that supplied the opportunity. Therefore, the publisher 108 is the entity which gets paid, and the auction winner is the candidate advertiser 104 that causes the publisher 108 to be paid the most.

The ad exchange server 120 may include memory 144, a processor 148, including modules for resolving path validity 152 and path optimality 154, as well as for performing latency adjustment 155 on the pool of ads according to the embodiments disclosed herein. Path optimality may also be referred to as maximizing the amount a publisher is paid with the chosen path through an exchange graph. The ad exchange server may further include a communication interface 156, an advertisements (ads) database 160, a users database 162, an exchange graph database 164, and other system storage 166 for software and algorithms executed by the ad exchange server 120 when conducting ad selection for advertisement display opportunities.

The communication interface 156 may communicate with the communication interface 136 of the web server 118 as well as function as a user interface for advertisers 104, publishers 108, ad-network entities 110, users 112, and agents thereof. Ads are stored in the ads database 160, which include a variety of properties associated with and stored in relation to the ads. User metadata and click history may be stored in relation to specific users in the users database 162, which includes interests and aspects of users that will generally be referred to as user properties. Exchange graph information, including predicates related to business relationships of participants in the exchange, are stored in mutual relation in the exchange graph database 164. These predicates include demand predicates and supply predicates, as well as legality predicates.

A demand predicate may be a function whose inputs include properties of one or more of the ads. The properties of the ads, therefore, are targetable by one or more demand predicates. A supply predicate may be a function whose inputs include properties of a user. The properties of the users, therefore, are targetable by one or more supply predicates. A legality predicate may be a Boolean AND of a supply predicate and a demand predicate at a node or edge of an exchange graph. Other logical relations may be used to combine a supply predicate and a demand predicate into a legality predicate, to constrain any node or edge of the exchange graph.

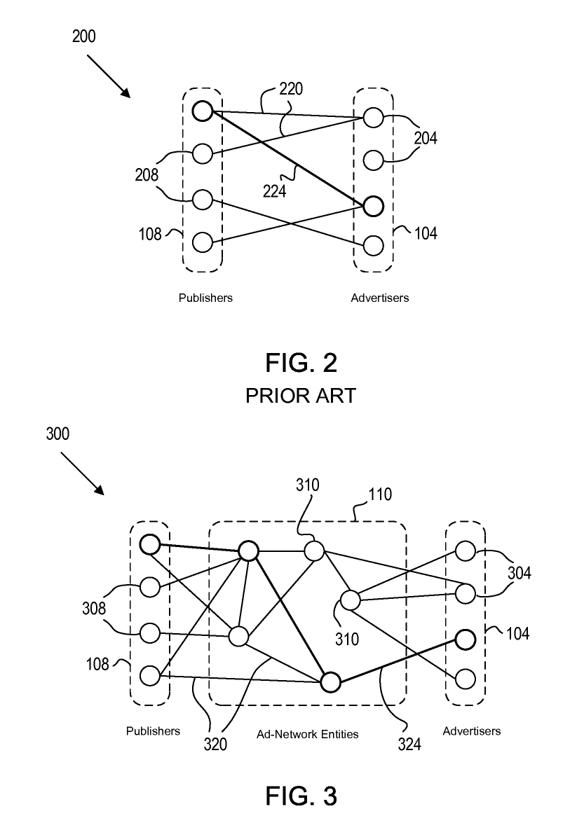

FIG. 2 is a diagram of a prior art exchange graph 200 showing the classic “flat” ad matching problem already discussed in the related art section above. A plurality of nodes 208 represents the publishers 108 and a plurality of other nodes 204 represents the advertisers 104 and their ads. A plurality of graph edges 220 represent interconnections directly between advertisers 104 having ads that may meet the legality and optimality requirements to fill display opportunities provided by the publishers 108. The ad exchange server 120 finds the optimal and legal path 224 between an opportunity of a publisher 108 and a specific advertisement of an advertiser 104, as discussed above. As discussed, this “flat” ad matching problem is the classic, more simplistic scenario that is relatively easy to solve. Although relatively easy to solve, the processing required to solve it has increased dramatically with the increase in submitted ads, as discussed. Accordingly, even the flat ad matching problem can be simplified, thus reducing serving latencies, through use of the methods for limiting latency described herein.

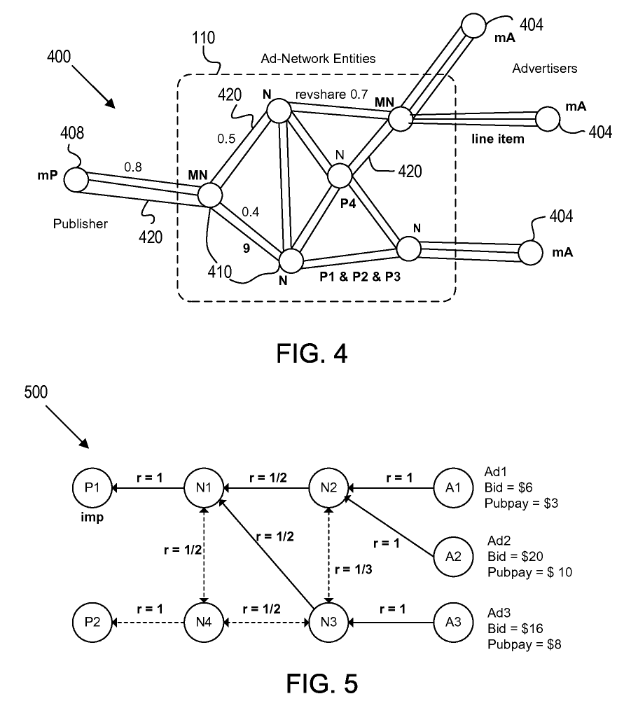

FIG. 3 displays a diagram of an exchange graph 300 showing an ad matching problem that includes intermediate ad-network entities 110 in addition to the publishers 108 and advertisers 104. Similar to FIG. 2, the exchange graph of FIG. 3 includes nodes 308 that represent the publishers 108 and nodes 304 that represent the advertisers 104. The added complexity in this exchange graph diagram 300 comes from the addition of nodes 310 that represent intermediate ad-network entities 110. A plurality of graph edges 320 interconnects the nodes 304, 310, 308 of the advertisers 104, the ad-network entities 110, and of the publishers 108, respectively. The ad exchange server 120 finds the optimal and legal path 324 through the exchange graph 300, which thus meets a plurality of legality predicates as discussed above, and maximizes payout to the publisher 108 providing an identified display opportunity.

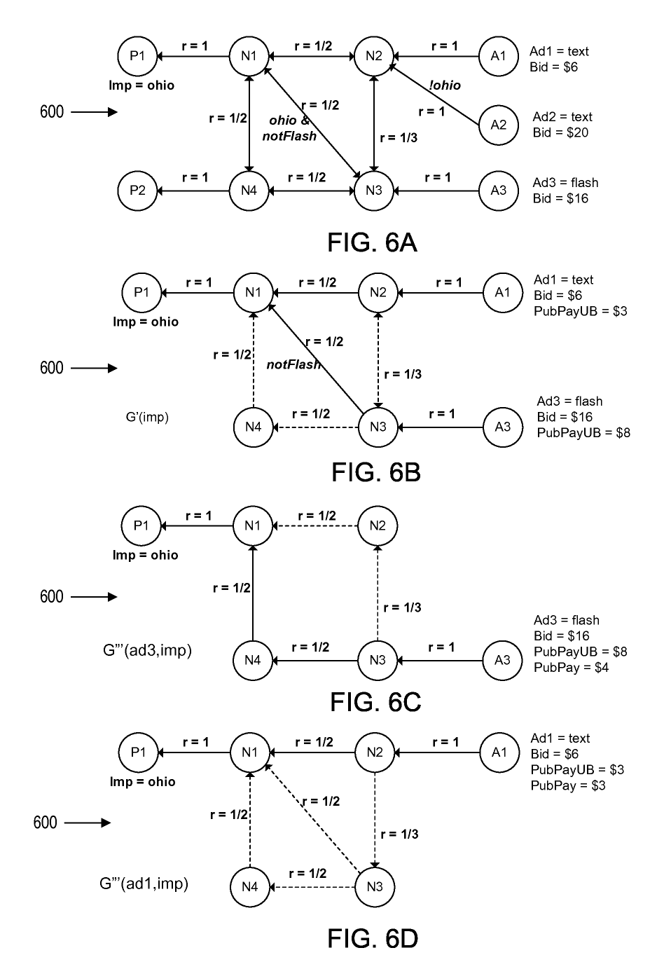

FIG. 4 is a diagram of a directed multigraph 400 showing some of the main features of the exchange graph that includes intermediate ad-network entities 110. A publisher node 408 represents the publisher 108 from which the ad exchange server 120 has received an ad display opportunity. The publisher 108 in this example is a “managed” publisher, meaning that the publisher 108 is managed over the network 116 by an intermediary ad-network entity 110 that set up that publisher 108 in the system 100. A number of advertisers 104 are in contention in bidding for the opportunity; these advertisers are also considered “managed” advertisers and are represented by a plurality of nodes 404. A number of the ad-network entities 110 are represented by a plurality of nodes 410. The union of these entities—the publishers 108, the advertisers 104, and the ad-network entities 110—together with potential links between the same is a directed multigraph. A multigraph is a multiset of unordered pairs of (not necessarily distinct) vertices (or nodes). Directed refers to an asymmetric relation within the edges of the graph, thus creating a certain direction to connect an advertiser node 404 to a publisher node 408, an advertiser node 404 to an ad-network node 410, and/or an ad-network node 410 to a publisher node 408, which connections are provided through a plurality of path edges 420. The participants in the auction are actually pairs, each including an ad, and a path in the exchange graph 400 that connects the publisher 108 of the impression with the advertiser 104 of the ad.

The nodes and edges of the multigraph 400 of the ad exchange contains many predicates (encoding business logic) that determine whether a given ad and path are legal for the current impression. These are also referred to as targeting predicates, which may exist in the nodes 404, 408, 410, the edges 420, and in the creatives of the ads, as well as in revenue sharing requirements on the edges 420. In the exchange, before implementation of the present methods and algorithms, the resulting constraint satisfaction problem was computationally intractable (NP-hard).

A major part of the current design project was a thorough review of all NGD exchange features to determine which ones are sources of the intractability mentioned above. In early stages of the design work, all such features were simply removed to create an efficiently solvable “core task.” That made it possible to design a corresponding polynomial-time “core algorithm.” Subsequently, all of the deleted features had to be re-instated, but with restrictions that prevented the re-introduction of intractability.

$$\begin{matrix}pubPay ( ( Ad , Path ) \vert imp ) = Bid ( Ad \vert imp ) \times {\prod }_{edge ∈ Path}^{ } RevShare ( edge ) & ( 1 ) \\ Legal ( ( Ad , Path ) \vert imp ) = Legal ( Ad \vert imp ) ⋀ {\prod }_{x ∈ Path}^{ } ( Legal ( x \vert imp ) ⋀ Legal ( x \vert Ad ) ) & ( 2 )\end{matrix}$$

The per-ad-call NGD auction can be formalized as a constrained optimization problem defined by an objective function pubPay((Ad,Path)|imp) and a legality function Legal((Ad,Path)|imp), shown in Equations 1 and 2, respectively. To explain the objective function in more detail, consider a bid by an advertiser, tⱼ, as an offer to pay money to a publisher 108 to show an ad to a user 112 having certain properties, x_{q}. A multiplier for a single edge along each path is designated as m(e) and falls in the interval (0, 1). Accordingly, a multiplier for an entire path is designated as M(p) and is given as Π_{eεp}m(e). Using this construct and notations, the score for an entire path between the opportunity and the ad is given as:

Score(x_{q},p)=B(x_{q},t(p))·M(p). (3)

This score represents the money actually received by the publisher 108 after a fraction of (1−M(p)) of the money is diverted to any intermediate ad-network entities 110 in the path. Accordingly, the objective function broadly written as Equation 1 seeks to maximize what the publisher is paid by choosing the path that shares the least revenue to the intermediate ad-network entities 110. This is the same as maximizing the score as expressed in Equation 3.

Depending on the details of the two functions in Equations 1 and 2, the constrained optimization problem can either be tractable or not. In the previously-implemented ad exchange, this problem was intractable (NP-hard). Equations 1 and 2 define a limited “core” version of the constrained optimization problem solvable by the ad exchange server 120 in polynomial time due to several simplifications and assumptions, some of which include:

1. Every graph edge is a “revenue share” edge that transmits a specified fraction of the money entering the edge.

2. The revenue share of a path is the product of the revenue shares of its edges. In some cases, one or more nodes of a path also include revenue shares that are multiplied into the product of revenue shares of the edges for the overall revenue share of the path.

3. The payment to the publisher is the bid of the advertiser times the revenue share of the path.

4. The legality of a path is an AND of the individual legality of every node and edge in that path.

5. The legality of a given node or edge generally depends on properties of the current impression and properties of a specific ad, both of which are fixed for the duration of the ad call.

6. More specifically, the legality of a given node or edge is defined to be the AND of two subpredicates, a supply predicate and a demand predicate, which respectively depend on properties of the impression and properties of the ad.

Points 1-3 are assumptions about the objective function, which allow it to be treated as an efficiently-solvable, min-cost path problem. Points 4-5 are assumptions about the constraints, which allow them to be handled by graph thinning, discussed below. Point 6 allows the impression-dependent “supply predicates” and the ad-dependent “demand predicates” to be handled by successive rounds of graph thinning.

Let N and E denote the number of nodes and edges in the directed multigraph that represent the ad exchange. Let A denote the number of ads in the ad pool, which is a group of ads that are available to bid on an impression generated by a publisher. All run times will be stated under the assumption that N<E. The Õ( ) notation indicates that log factors are suppressed in the cost analysis.

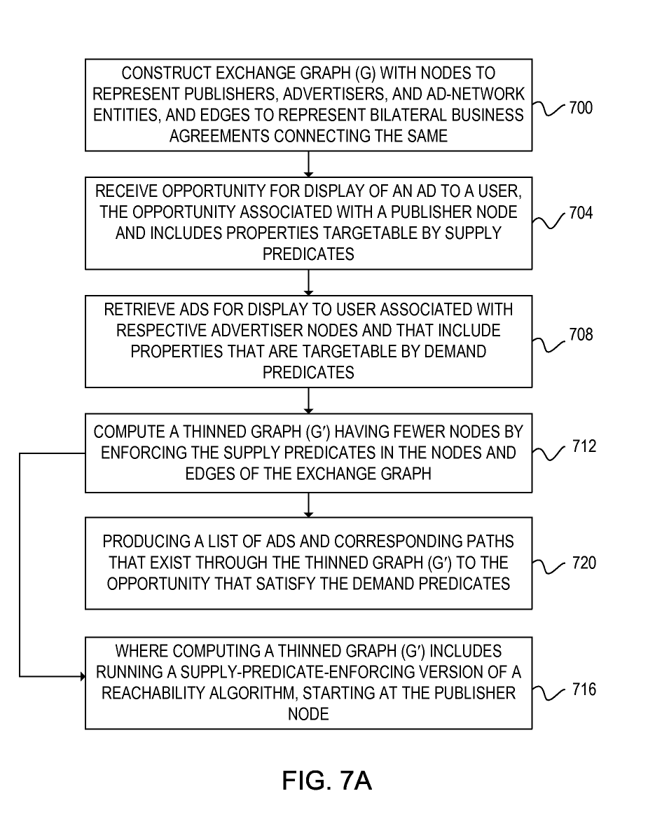

If there were no legality constraints at all, the problem could be solved in Õ(E+A) time by first running a minimum-cost-path algorithm, such as single-source Dijkstra, to simultaneously find optimal paths from the current publisher to every advertiser, then multiplying the revenue shares (revshares) of these optimal paths by the bids of the A ads to obtain A values of pubPay(ad,bestpath(P,advertiser(ad))), and finally picking the maximum such value. This scenario is depicted in FIG. 5, which displays a counterfactual scenario where an exchange graph 500 contains no legality constraints; the full best-path tree (drawn in solid lines) from P1 to all advertisers could be constructed in Õ(E) time by one single-source Dijkstra computation. The ad-path pair (ad2, bestpath(P1,A2)) would be the auction winner because its publisher payment of 10 dollars (1*0.5*1*20) dollars is maximal.

Dijkstra's algorithm is a graph search algorithm that solves the single-source shortest path problem for a graph with nonnegative edge path costs, producing a shortest path tree. This algorithm is often used in routing. For a given source vertex (node) in the graph, the algorithm finds the path with lowest cost (e.g., the shortest path) between that node and every other node. It can also be used for finding costs of shortest paths from a single node to a single destination node by stopping the algorithm once the shortest path to the destination node has been determined. For example, if the nodes of the graph represent cities and edge path costs represent driving distances between pairs of cities connected by a direct road, Dijkstra's algorithm can be used to find the shortest route between one city and all other cities. As a result, the shortest path is used first in network routing protocols.

If there were legality constraints of the limited form described in Equation 2 and points 4-6, but no ad-dependent predicates, then the problem could again be solved in Õ(E+A) time as follows: run the same algorithm, but this time on a thinned graph G′(imp) obtained from the original graph, G, by deleting all edges and nodes that are not legal for the current impression.

Since the exchange graph can in fact contain ad-dependent predicates, in the worst case Single-source single-sink Dijkstra should be run A times to find optimal legal publisher-to-advertiser paths in A different thinned graphs G″(ad, imp). The resulting Õ(A·E) worst case run time for one ad call is effectively quadratic and therefore unacceptable.

The factorization of predicates mentioned in point 6 discussed above can help in several ways. For example, the constant factor can be improved by a “progressive thinning” scheme that first converts G to G′(imp) by applying the impression-dependent predicates, then builds each G″(ad, imp) by applying the ad-dependent predicates to G′(imp).

Another useful strategy begins by using single-source Dijkstra to compute a best path tree from the publisher in G′(imp). The revshare of an optimal path in G is at least as good as the revshare of any path in any G″(ad, imp) that connects the same pair of nodes. The revshares of optimal paths in G′(imp), therefore, are upper bounds (UBs) on the revshares of optimal paths in every ad-specific graph G″(ad, imp).

These revshare UBs are valuable because they can be multiplied by bids to produce payout UBs that can be compared with a payout lower bound (LB) (established by the payout of any legal ad-path pair) to prove that certain ads cannot win the auction via any legal path. Any such guaranteed-to-lose ad can be discarded without performing a best path computation in its respective G″ (ad, imp).

Much work can be avoided if the candidate ads are processed in an order that causes the payout LB to rise quickly. An ordering heuristic scheme for achieving this is to sort and then consider the ads in decreasing order of bid multiplied by revshare upper bound (UB). If only a <<A ads typically end up requiring optimal path computations, then the typical run time would be the much more acceptable a·Õ(E). However, the worst-case run time would still be Õ(A·E), so for improved operability, the serving system may contain an “operability knob” (k) that imposes a hard limit on the number of best path computations per ad call. This operability knob will be discussed in more detail below with regards to sampling rates, and may be used to limit the latency of ad serving as generally discussed above. After use of the operability knob, the run time becomes the effectively linear min(a, k)·Õ(E).

In graph theory, reachability is the notion of being able to get from one vertex (or node) in a directed graph to some other vertex (or node). Note that reachability in undirected graphs is trivial: it is sufficient to find the connected components in the graph, which can be done in linear time. For a directed graph D=(V, A), the reachability relation of D is the transitive closure of its arc set A, which is to say the set of all ordered pairs (s, t) of vertices (nodes) in V for which there exist vertices ν₀=s, ν₁, . . . ν_{d}=t such that (νᵢ₋₁, νᵢ) is in A for all 1≦i≦d.

Algorithms for reachability fall into two classes: those that require pre-processing and those that do not. For the latter case, resolving a single reachability query can be done in linear time using algorithms such as breadth first search (BFS) or iterative deepening depth-first search. These algorithms are contemplated by this disclosure when “reachability” or “reachable” is referred to herein.

Major steps of the core algorithm executable by the ad exchange server 120, not all of which have to be executed for a functioning, useful algorithm, and their approximate costs include those listed below.

Step 1: Extract partially thinned subgraph G′(imp) by copying or marking nodes and edges that are reachable from the current publisher and are legal for the current impression (display opportunity). Cost: O(E).

Step 2: Use a minimum-cost-path algorithm such as single-source Dijkstra to compute optimal paths in G′(imp), connecting every advertiser to the publisher, and establishing upper bounds on the revshare of the corresponding paths in each respective ad-specific graph, G″ (ad,imp). Cost: Õ(E).

Step 3: Evaluate legality of all reachable ads. Cost: Õ(A).

Step 4: For all legal ads, get bids by calling a local or external bidding service, then multiply by the upper bounds (UBs) on revshare, obtaining upper bounds on every pubPay(ad), and finally sort the ads in decreasing order of these bounds. Cost: Õ(A). Calling a bidding service is the action of the ad exchange server 120 calling out for bids from the advertisers 104. A bidding service, whether internal to the exchange or external (third party), may implement any strategy (as in game theory strategy) on behalf of a buyer, typically optimizing a given utility or objective function. The NGD Exchange 120 supports various advertisement campaign pricing types such as CPM (cost-per-mille), CPC (cost-per-click) or CPA (cost-per-action), however, in order to participate in the auction, bids are normalized by the bidding service to a common estimated CPM (eCPM) “currency,” making use of response prediction models to compute the estimated probability that the user will respond to an ad via a click or an action.

Step 5: For each ad in a prefix of the sorted list, if the ad is still viable according to the bounds, use Single-source single-sink Dijkstra to compute an optimal path in the ad-specific graph, G″ (ad, imp). This produces a completely legal path and a corresponding value for pubpay(ad,path), and may result in an updated lower bound (LB). Stop after min(a, k) path computations, and serve the highest-paying (ad,path) pair so far. Cost: min(a, k)·Õ(E).

In some embodiments, upper and lower bounds need not be used as described in Steps 1-5, yet partially-thinned subgraph G′(imp) may still be extracted and optimal paths therethrough still computed.

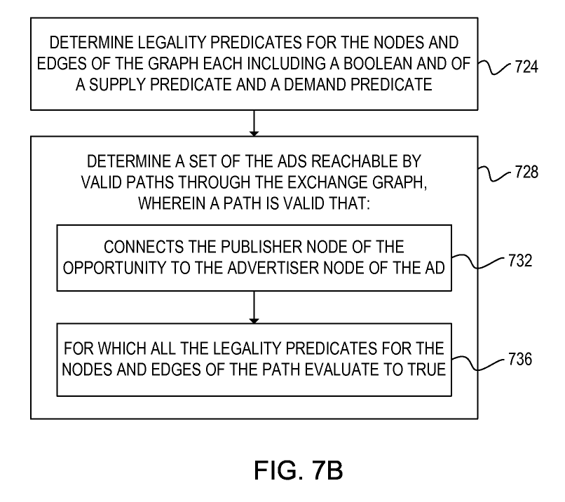

FIGS. 6A, 6B, 6C, and 6D is a series of related diagrams of exchange graphs 600, showing the progression of a core algorithm for ad selection of a sample ad in an ad exchange with intermediate ad-network entities. FIG. 6A is an exchange graph (G) containing two publisher nodes, four ad-network nodes, and three advertiser nodes each contributing one ad to the ad pool. Each graph edge has a revshare multiplier as indicated by “r” along the edges. Two of the edges are annotated by legality predicates (ohio & notFlash and !ohio) referring to properties of impressions and ads. Now suppose that publisher P1 gets an impression for a user that lives in Ohio.

Step 1 computes the partially thinned graph G′(imp) which appears in FIG. 6B. Notice that A2 and ad2 have disappeared, because the predicate notOhio(imp) on edge N2-A2 was not satisfied. Also, the predicate on edge N1-N3 has been simplified by omitting the already-satisfied predicate Ohio(imp).

Step 2 uses single-source Dijkstra to compute the provisional best path tree drawn in solid lines in FIG. 6B, plus upper bounds on the revshare of legal paths between the publisher and all advertisers. These upper bounds turn out to be 0.5 for both A1 and A3. The computations in Steps 3 and 4 then yield the following sorted list of ad candidates: [(ad3, bid=$16, pubPayUB=$8); (ad1, bid=$6, pubPayUB=$3)].

In Step 5, Ad3 is therefore processed first. Conceptually, the graph G″(ad3, imp) shown in FIG. 6C is constructed. The edge N1-N3 has disappeared because notFlash(ad3) is false. This invalidates the provisional best path to A3, which was responsible for the revshare UB of 0.5. A Single-source single-sink Dijkstra computation, this time run on G″(ad3, imp), finds a new best path between P1 and A3. Its revshare is 0.25, so the final payment to the publisher is pubpay(ad3)=$4. This payment also updates the lower bound pubPayLB, which controls the skipping of subsequent ad candidates. In this example, pubP ayUB(ad1)=$3<pubPayLB=$4, so Ad1 can in fact be discarded without performing a best path computation in G″(ad1, imp).

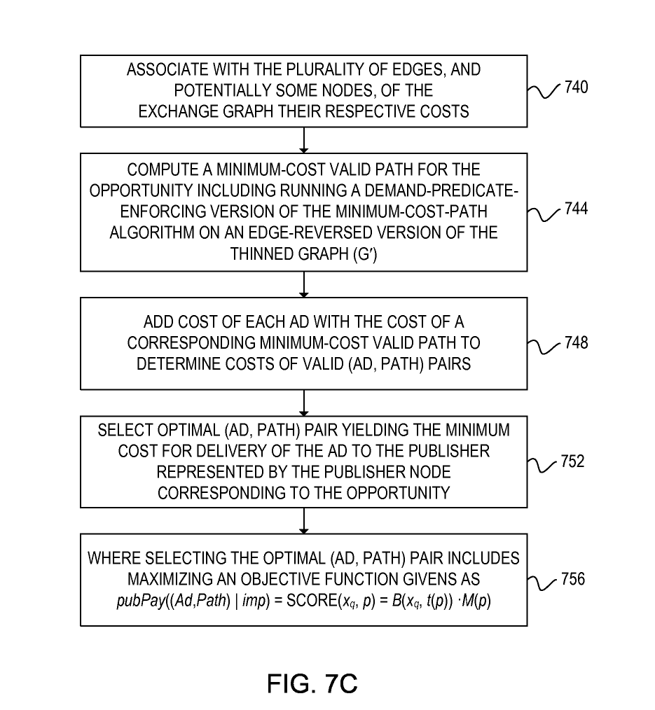

For completeness this (unnecessary) graph G″(ad1, imp) is provided as FIG. 6D, as well as the optimal legal path that Single-source single-sink Dijkstra would have found. This turns out to be the same as the provisional best path for ad1, so pubPayUB(ad1) was tight in this case. FIGS. 7A, 7B, and 7C are flow diagrams of an exemplary method for efficient ad selection in an ad exchange with intermediate ad-network entities 110 that expands on at least some of the steps of the “core algorithm” disclosed above. The method may be executed by the ad exchange server 120 with a processor and system storage, wherein the ad exchange server 120 may be coupled with the web server 118, as discussed above.

In block 700, the method constructs an exchange graph (G), in memory of the server, including nodes representing a plurality of publishers and advertisers, and one or more intermediate entities, the exchange graph also including a plurality of directed edges that represent bilateral business agreements connecting the nodes. In block 704, it receives an opportunity for displaying an ad to a user, wherein the opportunity is associated with a publisher node and includes properties that are targetable by a plurality of supply predicates, wherein a supply predicate includes a function whose inputs include properties of the user. At block 708, it retrieves a plurality of ads that are available for display to the user associated with respective advertiser nodes and that include properties that are targetable by a plurality of demand predicates, wherein a demand predicate includes a function whose inputs include properties of one or more of the plurality of ads. At block 712, it computes a thinned graph (G′) having fewer nodes by enforcing the supply predicates in the nodes and edges of the graph (G). At block 716, computing the thinned graph (G′) may include running a supply-predicate-enforcing version of a reachability algorithm, starting at the publisher node of the opportunity. And, at block 720, it produces a list of ads and corresponding paths that exist through the thinned graph (G′) to the opportunity that satisfy the plurality of demand predicates, and thus may be used to fill the display opportunity.

At block 724, the method determines a plurality of legality predicates for association with the nodes and edges of the graph, the legality predicates each including a Boolean AND of a supply predicate and a demand predicate. At block 728, to compute the thinned graph (G′) and produce the list of ads for the opportunity, the method determines a set of the ads reachable by valid paths through the graph (G), wherein a path is valid that, at block 732, connects the publisher node of the opportunity to the advertiser node of an ad; and, at block 736, for which all of the legality predicates for the nodes and edges evaluate to true.

At block 740, the method further associates with the plurality of edges, and potentially some nodes, of the graph their respective costs. At block 744, it computes a minimum-cost valid path for the opportunity comprising running a demand-predicate-enforcing version of a minimum-cost-path algorithm on an edge-reversed version of the thinned graph (G′), starting at each of at least some of the advertiser nodes. The edge costs may include a negative logarithm of a revenue share multiplier affiliated with respective edges, wherein the minimum-cost-path algorithm comprises Dijkstra's algorithm, and wherein the result of running Dijkstra's algorithm is a maximum revenue path, per impression, to the publisher node corresponding to the opportunity. At block 748, the method further adds the cost of each ad with the cost of a corresponding minimum-cost valid path to determine costs of valid (ad, path) pairs. At block 752, it selects the optimal (ad, path) pair yielding the minimum cost for delivery of the ad to the publisher represented by the publisher node corresponding to the opportunity.

At block 756, the method selects the optimal (ad, path) pair by maximizing an objective function given as Equation 1. Equation 1 may further be expressed in more detail as Equation 3, or Score(x_{q}, p)=B(x_{q}, t(p))·M(p), wherein bid B(x_{q}, tⱼ) is an offer by advertiser tⱼ to pay money for showing an ad to a user having properties x_{q}, where M(p) is given as Π_{eεp} m(e), a multiplier for an entire path where m(e) is a multiplier for a single edge lying in an interval (0,1), and where Score(x_{q},p) represents the money received by the publisher after some money is diverted to the intermediate business entities.

The operability knob (k) or latency adjustment that was discussed previously should be meaningful to achieve bounded latency in ad serving as well as good scalability. A meaningful strategy will effectively reduce latency and increase scalability while minimizing its business impact in terms of average revenue across the exchange. A couple different latency adjustmmnt strategies were considered, including: (1) taking the top-k ads based on some deterministic scoring function that combines an estimate eCPM and possibly the rev-share upper bounds (UBR); and (2) downsampling the pool of ads in some way to reduce, from the outset, the number of ads that will be analyzed in steps of the core algorithm by the exchange server 120.

With regards to strategy number one (1), reliable and fast probability estimation would be desirable. If the strategy systematically removes some ads that never make it to the top-k, the approach may have a serious implication for ad learning, which is the mechanism by which the system 100 displays all new ads at least a few times so that the probability of a click or action can be estimated. Without having an estimate for the probability of click and/or conversion, the strategy could still consider the raw bid and the UBR as indicators of the final bid. The main challenge here is that all ads sharing the same campaign will have the same raw-bid, and thus cannot be differentiated.

With regards to strategy number two (2), sampling has the advantage of being ad learning friendly; however, it poses no guarantee or attempt to predict the expected winner being among the sampled ads. Moreover, sampling does not take advantage of any heuristic or estimate that might increase the chance of getting the expected winner in the sampled set. Since there is no way, presently, of comparing different pricing types (CPC, CPA, CPM), sampling would need to be done among ads of comparable per pricing type. Finally, proportional sampling across all advertisers 104 may give an unrealistic advantage to large advertisers that are over-represented compared to other smaller advertisers.

Considering these two strategies, a sampling strategy has been developed in which random sampling is used to reduce the size of the ad pool to a smaller, target subset of ads (S), but only if the ad pool is too big, e.g., beyond a threshold (T) size, where T>S. Accordingly, if the ad pool submitted by all eligible advertisers to participate in the auction is beyond T, the exchange server 120, through its latency adjustment module 155, will perform sampling to generate a reduced ad pool S. If the value of T is larger than the typical ad pool size, then sampling will rarely occur, wherein the ad knob will function as a safety valve protecting against sudden increases in the size of the ad pool that could be caused by advertisers 104 introducing a huge number of new ads. Alternatively, the value of T could be small enough to usually cause some ads to be discarded, in which case it will control a revenue versus latency tradeoff. In practice, S is chosen to be sufficiently smaller than T so that the latency reduction caused by having a smaller ad pool after this step is sufficient to pay for the work of actually doing the random sampling. Furthermore, the overall ad pool is considered to be the union of numerous subsets, each from an advertiser 104, and a biased random sampling scheme may be employed that downsamples larger subsets more. Additionally, the random downsampling may occur before or after the exchange server 120 finds the plurality of reachable, legal (ad, path) pairs for the ad pool, but before calling out to the target number of ads (S) to request for bids.

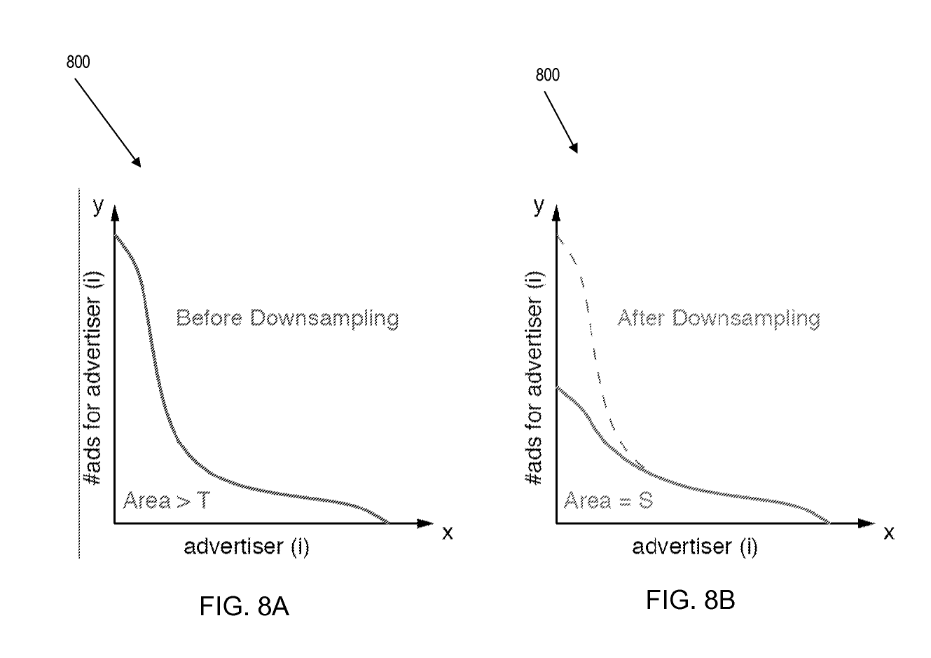

In sampling, the exchange server 120 will, if the size of the ad pool is above the threshold T, determine a number of ads submitted per advertiser that will trigger sampling for a particular advertiser. FIG. 8A is a graph 800 of an exemplary ad pool in which the advertisers are located along the x-axis in decreasing order according to the number of ads they submit to the auction, and the y-axis represents the number of ads from a given advertiser. The curve shows the distribution of ads amongst the advertisers, and the area under the curve represents the total number of ads in the ad pool for the current ad call. Because this total exceeds the threshold, T, the system will downsample some of the advertisers to generate the modified ad count distribution—a sampled subset (S)—shown in FIG. 8B. The biggest or most participating advertisers have been downsampled the most. The smallest or least participating advertisers have not been downsampled at all. The area under the modified curve shown in FIG. 8B, which represents the new total number of ads, is substantially equal to S.

Accordingly, one embodiment selected for executing the sampling discussed above was to use a squashing/smoothing function to determine the percentage of participation of an advertiser, thus the size of the random sample per advertiser. Based on advertiser participation rate, for a specific ad call, advertisers that participate more will be sampled based on the squashing/smoothing function. Advertisers that barely participate will not be sampled at all, or in other words, the exchange server 120 will take all of their ads. The squashing/smoothing function for the target number of ads (s_{qi}) for a given ad call (q) and advertiser (i) may be given by

s_{qi}=min(t_{qi},z_{q}*SHAPE(t_{qi})) (4)

where t_{qi} is the total number of ads for advertiser (i) during the ad call (q), and the value of z_{q} for ad call (q) is obtained by solving

$$S = {\sum }_{i}^{ } {s}_{qi} = {\sum }_{i} min ( {t}_{qi} , {z}_{q} * SHAPE ( {t}_{qi} ) ) , \qquad ( 5 )$$

where SHAPE(x) is an increasing, concave-down function such as the square root of x, SQRT(x), x**p for a power between 0 and 1, or LOGARITHM(x). Other types of increasing (or more generally, non-decreasing) concave-down functions are also contemplated that increasingly downsample the number of ads with growing numbers of ads submitted by an advertiser 104 that is sampled. Based on Equations 4 and 5, the sample size for a given advertiser will be: (1) t_{qi} when t_{qi}<z_{q}*SHAPE(t_{qi}); or (2) z_{q}*SHAPE(t_{qi}) when t_{qi} is greater than or equal to z_{q}*SHAPE(t_{qi}).

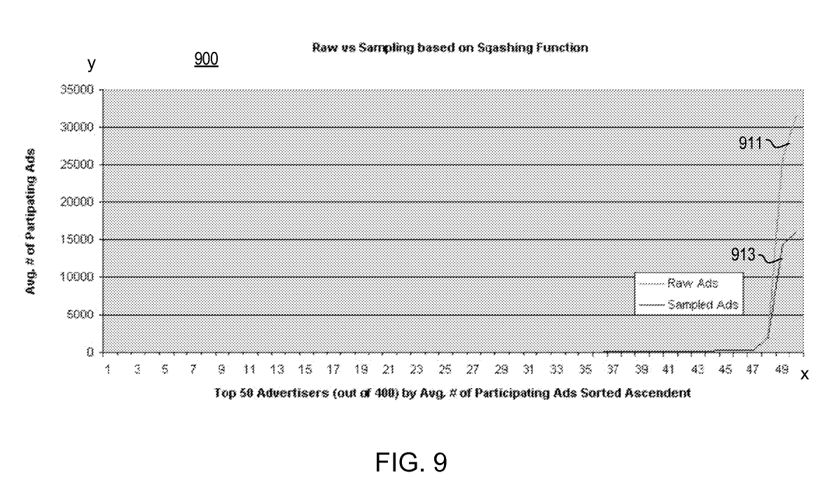

FIG. 9 is a graph 900 depicting the difference in average number of ads participating per ad call between sampling and not sampling the top 50 advertisers out of 400 considered the most participating advertisers. Line 911 represents the raw ads (submitted by all advertisers 104) and line 913 represents the sampled ads after downsampling is executed as just discussed. Notice that only few (less than 5) advertisers 104 get sampled, which are at the very end of the inverted very long tail of advertisers 104.

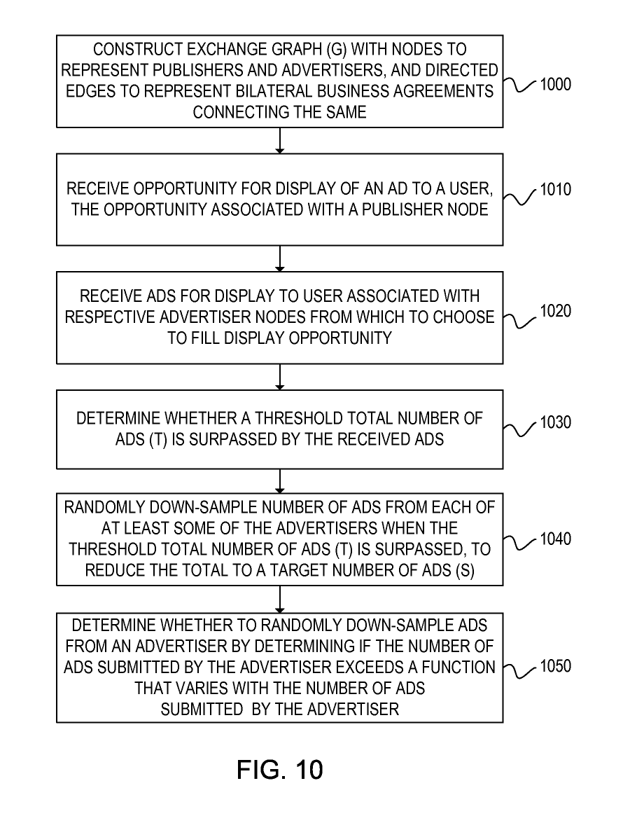

FIG. 10 is a flow diagram of an exemplary method for limiting latency in filling a display opportunity in an ad exchange 120. The method, at block 1000, constructs an exchange graph (G) including nodes representing a plurality of publishers and advertisers, the exchange graph also including a plurality of directed edges that represent bilateral business agreements connecting the nodes. At block 1010, it receives an opportunity for displaying an ad to a user, wherein the opportunity is associated with a publisher node. At block 1020, it receives a plurality of ads from the plurality of advertisers from which to choose to fill the display opportunity. At block 1030, the method determines whether a threshold total number of ads (T) is surpassed by the plurality of received ads. At block 1040, it randomly downsamples the number of ads from each of at least some of the plurality of advertisers when the threshold total number of ads (T) is surpassed by the plurality of received ads to reduce the total number of ads to a target number of ads (S) that reduces overall latency in determining which of the plurality of sampled ads will fill the display opportunity. At block 1050, the method may determine whether to randomly downsample ads from an advertiser by determining if the number of ads submitted by the advertiser exceeds a function that varies with the number of ads submitted by the advertiser. Such a function may include those discussed with reference to Equations 4 and 5.

Based on data and analysis of expensive and normal ad calls, including both winners and participants, there is little evidence that high participants (or abusers) win a lot. In fact, the opposite seems to be true. Also noticed was that, for expensive ad calls, the ratio of participation to number of wins for CPA and CPC pricing types is much lower than for other pricing types, which suggests that very large number of non-winning participants from advertisers that bring in large number of ads to compete are of CPA and CPC types which is free for them.

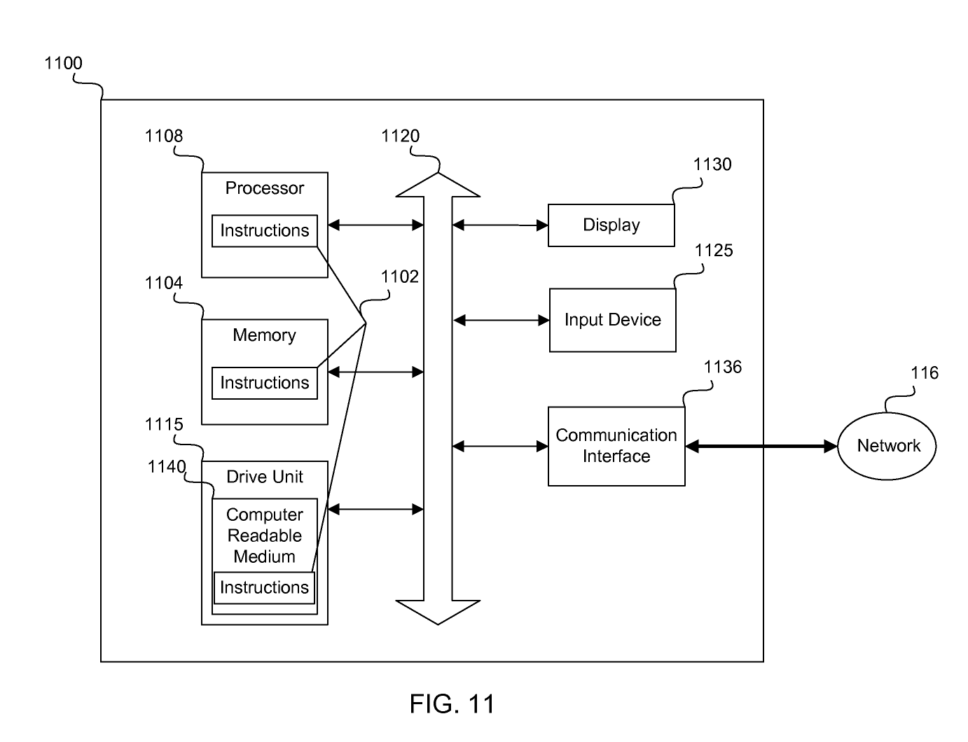

FIG. 11 illustrates a general computer system 1100, which may represent the web server 118, the ad exchange server 120, the user browser 114, or any other computing devices referenced herein, such as client computers of the users 112, the advertisers 104, the publishers 108, and the ad-network entities 110. The computer system 1100 may include an ordered listing of a set of instructions 1102 that may be executed to cause the computer system 1100 to perform any one or more of the methods or computer-based functions disclosed herein. The computer system 1100 may operate as a stand-alone device or may be connected, e.g., using the network 116, to other computer systems or peripheral devices.

In a networked deployment, the computer system 1100 may operate in the capacity of a server or as a client-user computer in a server-client user network environment, or as a peer computer system in a peer-to-peer (or distributed) network environment. The computer system 1100 may also be implemented as or incorporated into various devices, such as a personal computer or a mobile computing device capable of executing a set of instructions 1102 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 1100 may include a processor 1108, such as a central processing unit (CPU) and/or a graphics processing unit (GPU). The processor 1108 may include one or more general processors, digital signal processors, application specific integrated circuits, field programmable gate arrays, digital circuits, optical circuits, analog circuits, combinations thereof, or other now known or later-developed devices for analyzing and processing data. The processor 1108 may implement the set of instructions 1102 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 1100 may include a memory 1104 on a bus 1120 for communicating information. Code operable to cause the computer system to perform any of the acts or operations described herein may be stored in the memory 1104. The memory 1104 may be a random-access memory, read-only memory, programmable memory, hard disk drive or any other type of volatile or non-volatile memory or storage device.

The computer system 1100 may also include a disk or optical drive unit 1115. The disk drive unit 1115 may include a computer-readable medium 1140 in which one or more sets of instructions 1102, e.g., software, can be embedded. Further, the instructions 1102 may perform one or more of the operations as described herein. The instructions 1102 may reside completely, or at least partially, within the memory 1104 and/or within the processor 1108 during execution by the computer system 1100. Accordingly, the databases 140, 160, 162, 164, and 166 described above in FIG. 1 may be stored in the memory 1104 and/or the disk unit 1115.

The memory 1104 and the processor 1108 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 1100 may include an input device 1125, such as a keyboard or mouse, configured for a user to interact with any of the components of system 1100. It may further include a display 1130, such as a liquid crystal display (LCD), a cathode ray tube (CRT), or any other display suitable for conveying information. The display 1130 may act as an interface for the user to see the functioning of the processor 1108, or specifically as an interface with the software stored in the memory 1104 or the drive unit 1115.

The computer system 1100 may include a communication interface 1136 that enables communications via the communications network 116. The network 116 may include wired networks, wireless networks, or combinations thereof. The communication interface 1136 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system serving advertisements and interfaces that convey additional information related to the advertisement. For example, the system generates browser code operable by a browser to cause the browser to display a web page of information that includes an advertisement. The advertisement may include a graphical indicator that indicates that the advertisement is associated with an interface that conveys additional information associated with the advertisement. The browser code is operable to cause the browser to detect a selection of the graphical indicator, and display the interface along with the information displayed on the web page in response to the selection of the graphical indicator. The advertisement and the additional information conveyed via the interface are submitted by an advertiser during an advertisement submission time.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

1. A method for limiting latency in filling a display opportunity in an ad exchange, the method executed with a server having a processor and system storage, comprising:
a) constructing an exchange graph (G), in memory of the server, comprising nodes representing a plurality of publishers and advertisers, the exchange graph also including a plurality of directed edges that represent bilateral business agreements connecting the nodes;
b) receiving, by the server, an opportunity for displaying an ad to a user, wherein the opportunity is associated with a publisher node;
c) receiving, by the server, a plurality of ads from the plurality of advertisers from which to choose to fill the display opportunity;
d) determining, by the server, whether a threshold total number of ads (T) is surpassed by the plurality of received ads; and
e) randomly downsampling, by the server, the number of ads from each of at least some of the plurality of advertisers when the threshold total number of ads (T) is surpassed by the plurality of received ads to reduce the total number of ads to a target number of ads (S) that reduces overall latency in determining which of the plurality of sampled ads will fill the display opportunity.

2. The method of claim 1, further comprising:
determining, by the server, whether to randomly downsample ads from an advertiser by determining if the number of ads submitted by the advertiser exceeds a function that varies with the number of ads submitted by the advertiser.

3. The method of claim 1, wherein the target number of ads (s_{qi}) for a given ad call (q) and advertiser (i) is given by s_{qi}=min(t_{qi}, z_{q}*SHAPE(t_{qi})) where t_{qi} is the total number of ads for advertiser (i) during the ad call (q), and the value of z_{q} for ad call (q) is obtained by solving
$$S = {\sum }_{i}^{ } {s}_{qi} = {\sum }_{i} min ( {t}_{qi} , {z}_{q} * SHAPE ( {t}_{qi} ) ) ,$$
where SHAPE(x) is a non-decreasing, concave-down function.

4. The method of claim 1, wherein the advertisers that are randomly downsampled use a pricing type selected from group consisting of a cost-per-action (CPA) pricing type, which advertisers are charged nothing for a submitted ad until a user makes a purchase after selecting the ad, and a cost-per-click (CPC) pricing type, which advertisers are charged nothing for a submitted ad until a user clicks on the ad.

5. The method of claim 1, further comprising:
calling out, by the server, to the target number of ads (S) to request for bids to fill the display opportunity.

6. The method of claim 5, wherein the exchange graph further includes a plurality of nodes that represent a plurality of intermediate networks that connect the advertiser nodes with the publisher nodes, wherein the display opportunity includes properties that are targetable by a plurality of supply predicates, wherein a supply predicate comprises a function whose inputs include properties of a user, and wherein the plurality of ads include properties that are targetable by a plurality of demand predicates, wherein a demand predicate comprises a function whose inputs include properties of one or more of the plurality of ads, the method further comprising:
determining, by the server, a plurality of legality predicates for association with the nodes and edges of the graph, the legality predicates each comprising a Boolean AND of a supply predicate and a demand predicate;
determining, by the server, a plurality of (ad, path) pairs for which the targeted ads (S) are reachable from the publisher node of the display opportunity and that satisfy the plurality of legality predicates in the nodes and edges of the paths of the exchange graph; and
choosing, by the server, the (ad, path) pair to fill the display opportunity that maximizes pay to the publisher providing the display opportunity.

7. The method of claim 6, wherein the random downsampling occurs after the server finds the plurality of reachable, legal (ad, path) pairs, but before calling out to the target number of ads (S) to request for bids.

8. A computer-readable storage medium comprising a set of instructions for limiting latency in filling a display opportunity in an ad exchange, the method executed with a server, the set of instructions to direct a processor to perform the acts of:
a) constructing an exchange graph (G), in memory of the server, comprising nodes representing a plurality of publishers and advertisers, the exchange graph also including a plurality of directed edges that represent bilateral business agreements connecting the nodes;
b) receiving, by the server, an opportunity for displaying an ad to a user, wherein the opportunity is associated with a publisher node;
c) receiving, by the server, a plurality of ads from the plurality of advertisers from which to choose to fill the display opportunity;
d) determining, by the server, whether a threshold total number of ads (T) is surpassed by the plurality of received ads; and
e) randomly downsampling, by the server, the number of ads from each of at least some of the plurality of advertisers when the threshold total number of ads (T) is surpassed by the plurality of received ads to reduce the total number of ads to a target number of ads (S) that reduces overall latency in determining which of the plurality of sampled ads will fill the display opportunity.

9. The computer-readable storage medium of claim 8, further comprising a set of instructions to direct a processor to perform the acts of:
determining, by the server, whether to randomly downsample ads from an advertiser by determining if the number of ads submitted by the advertiser exceeds a function that varies with the number of ads submitted by the advertiser.

10. The computer-readable storage medium of claim 8, further comprising a set of instructions to direct a processor to perform the acts of:
calling out, by the server, to the target number of ads (S) to request for bids to fill the display opportunity, wherein the target number of ads (s_{qi}) for a given ad call (q) and advertiser (i) is given by s_{qi}=min(t_{qi}, z_{q}*SHAPE(t_{qi})) where t_{qi} is the total number of ads for advertiser (i) during the ad call (q), and the value of z_{q} for ad call (q) is obtained by solving
$$S = {\sum }_{i}^{ } {s}_{qi} = {\sum }_{i} min ( {t}_{qi} , {z}_{q} * SHAPE ( {t}_{qi} ) ) ,$$
where SHAPE(x) is an increasing, concave-down function comprising one selected from the group consisting of SQRT(x) and LOGARITHM(x).

11. The computer-readable storage medium of claim 8, wherein the advertisers that are randomly downsampled use a pricing type selected from the group consisting of a cost-per-action (CPA) pricing type, which advertisers are charged nothing for a submitted ad until a user makes a purchase after selecting the ad, and a cost-per-click (CPC) pricing type, which advertisers are charged nothing for a submitted ad until a user clicks on the ad.

12. The computer-readable storage medium of claim 8, further comprising a set of instructions to direct a processor to perform the acts of:
calling out, by the server, to the target number of ads (S) to request for bids to fill the display opportunity.

13. The computer-readable storage medium of claim 12, wherein the exchange graph further includes a plurality of nodes that represent a plurality of intermediate networks that connect the advertiser nodes with the publisher nodes, wherein the display opportunity includes properties that are targetable by a plurality of supply predicates, wherein a supply predicate comprises a function whose inputs include properties of a user, and wherein the plurality of ads include properties that are targetable by a plurality of demand predicates, wherein a demand predicate comprises a function whose inputs include properties of one or more of the plurality of ads, the method further comprising:
determining, by the server, a plurality of legality predicates for association with the nodes and edges of the graph, the legality predicates each including a combination of a supply predicate and a demand predicate;
determining, by the server, a plurality of (ad, path) pairs for which the targeted ads (S) are reachable from the publisher node of the display opportunity and that satisfy the plurality of legality predicates in the nodes and edges of the paths of the exchange graph; and
choosing, by the server, the (ad, path) pair to fill the display opportunity that maximizes pay to the publisher providing the display opportunity.

14. The computer-readable storage medium of claim 13, wherein the random downsampling occurs after the server finds the plurality of reachable, legal (ad, path) pairs, but before calling out to the target number of ads (S) to request for bids.

15. A system for limiting latency in filling a display opportunity in an ad exchange, comprising:
a) an ad exchange server including a processor and computer storage, the exchange server coupled with a web server, wherein the processor is configured to:
i) construct an exchange graph (G), in memory of the server, comprising nodes representing a plurality of publishers and advertisers, the exchange graph also including a plurality of directed edges that represent bilateral business agreements connecting the nodes;
ii) receive from the web server an opportunity for displaying an ad to a user, wherein the opportunity is associated with a publisher node;
iii) receive a plurality of ads from the plurality of advertisers from which to choose to fill the display opportunity;
iv) determine whether a threshold total number of ads (T) is surpassed by the plurality of received ads; and
v) randomly downsample the number of ads from each of at least some of the plurality of advertisers when the threshold total number of ads (T) is surpassed by the plurality of received ads to reduce the total number of ads to a target number of ads (S) that reduces overall latency in determining which of the plurality of sampled ads will fill the display opportunity.

16. The system of claim 15, wherein the processor is further configured to determine whether to randomly downsample ads from an advertiser by determining if the number of ads submitted by the advertiser exceeds a function that varies with the number of ads submitted by the advertiser.

17. The system of claim 15, wherein the target number of ads (s_{qi}) for a given ad call (q) and advertiser (i) is given by s_{qi}=min(t_{qi}, z_{q}*SHAPE(t_{qi})) where t_{qi} is the total number of ads for advertiser (i) during the ad call (q), and the value of z_{q} for ad call (q) is obtained by solving
$$S = {\sum }_{i}^{ } {s}_{qi} = {\sum }_{i} min ( {t}_{qi} , {z}_{q} * SHAPE ( {t}_{qi} ) ) ,$$
where SHAPE(x) is an increasing, concave-down function comprising one selected from the group consisting of SQRT(x) and LOGARITHM(x).

18. The system of claim 15, wherein the advertisers that are randomly downsampled use a pricing type selected from the group consisting of cost-per-action (CPA) pricing type, which advertisers are charged nothing for a submitted ad until a user makes a purchase after selecting the ad, and a cost-per-click (CPC) pricing type, which advertisers are charged nothing for a submitted ad until a user clicks on the ad.

19. The system of claim 15, wherein the processor is further configured to call out to the target number of ads (S) to request for bids to fill the display opportunity.

20. The system of claim 19, wherein the exchange graph further includes a plurality of nodes that represent a plurality of intermediate networks that connect the advertiser nodes with the publisher nodes, wherein the display opportunity includes properties that are targetable by a plurality of supply predicates, wherein a supply predicate comprises a function whose inputs include properties of a user, and wherein the plurality of ads include properties that are targetable by a plurality of demand predicates, wherein a demand predicate comprises a function whose inputs include properties of one or more of the plurality of ads, wherein the processor is further configured to:
determine a plurality of legality predicates for association with the nodes and edges of the graph, the legality predicates each comprising a Boolean AND of a supply predicate and a demand predicate;
determine a plurality of (ad, path) pairs for which the targeted ads (S) are reachable from the publisher node of the display opportunity and that satisfy the plurality of legality predicates in the nodes and edges of the paths of the exchange graph; and
choose the (ad, path) pair to fill the display opportunity that maximizes pay to the publisher providing the display opportunity;
wherein the random downsampling occurs after the server finds the plurality of reachable, legal (ad, path) pairs, but before calling out to the target number of ads (S) to request for bids.
